(19) United States
(12) Patent Application Publication
(10) Pub. No.: US 2006/0240292 A1
(43) Pub. Date: Oct. 26, 2006

(54) Fuel cell

(76) Inventors: Qunhui Guo, North Andover, MA (US); Hao Tang, Montreal (CA); Zhigang Qi, Albany, NY (US); Bin Du, Clifton Park, NY (US); Noel Miklas, Gansevoort, NY (US)

Correspondence Address: FISH & RICHARDSON PC, P.O. BOX 1022, MINNEAPOLIS, MN, 55440-1022, US

(21) Appl. No.: 11/112,117

(22) Filed: Apr. 22, 2005

(51) Int. Cl. H01M 8/00; H01M 8/10

(52) U.S. Cl. 429/13; 429/30

(57) ABSTRACT

Fuel cells and related systems and methods are disclosed.

### TECHNICAL FIELD

This invention relates to fuel cells and related systems and methods.

### BACKGROUND

A fuel cell can convert chemical energy to electrical energy by promoting electrochemical reactions of two reactants.

One type of fuel cell includes a cathode flow field plate, an anode flow field plate, a membrane electrode assembly disposed between the cathode flow field plate and the anode flow field plate, and diffusion layers disposed between the cathode flow field plate and the anode flow field plate. A fuel cell can also include one or more coolant flow field plates disposed adjacent the exterior of the anode flow field plate and/or the exterior of the cathode flow field plate.

Each reactant flow field plate has an inlet region, an outlet region and open-faced channels connecting the inlet region to the outlet region and providing a way for distributing the reactants to the membrane electrode assembly.

The membrane electrode assembly usually includes a solid electrolyte (e.g., a proton exchange membrane) between a first catalyst and a second catalyst. One diffusion layer is between the first catalyst and the anode flow field plate, and another diffusion layer is between the second catalyst and the cathode flow field plate.

During operation of the fuel cell, one of the reactants (the anode reactant) enters the anode flow field plate at the inlet region of the anode flow field plate and flows through the channels of the anode flow field plate toward the outlet region of the anode flow field plate. The other reactant (the cathode reactant) enters the cathode flow field plate at the inlet region of the cathode flow field plate and flows through the channels of the cathode flow field plate toward the cathode flow field plate outlet region.

As the anode reactant flows through the channels of the anode flow field plate, some of the anode reactant passes through the anode diffusion layer and interacts with the anode catalyst. Similarly, as the cathode reactant flows through the channels of the cathode flow field plate, some of the cathode reactant passes through the cathode diffusion layer and interacts with the cathode catalyst.

The anode catalyst interacts with the anode reactant to catalyze the conversion of the anode reactant to reaction intermediates. The reaction intermediates include ions and electrons. The cathode catalyst interacts with the cathode reactant and the anode reaction intermediates to catalyze the conversion of the cathode reactant to the chemical product of the fuel cell reaction.

The chemical product of the fuel cell reaction flows through a diffusion layer to the channels of a flow field plate (e.g., the cathode flow field plate). The chemical product then flows along the channels of the flow field plate toward the outlet region of the flow field plate.

The electrolyte provides a barrier to the flow of the electrons and reactants from one side of the membrane electrode assembly to the other side of the membrane electrode assembly. However, the electrolyte allows ionic reaction intermediates to flow from one side of the membrane electrode assembly (e.g., anode) to the other side of the membrane electrode assembly (e.g., cathode).

Therefore, the ionic reaction intermediates can flow from the anode side of the membrane electrode assembly to the cathode side of the membrane electrode assembly without exiting the fuel cell. In contrast, the electrons flow from the anode side of the membrane electrode assembly to the cathode side of the membrane electrode assembly by electrically connecting an external load between the anode flow field plate and the cathode flow field plate. The external load allows the electrons to flow from the anode side of the membrane electrode assembly, through the anode flow field plate, through the load and to the cathode flow field plate, and the cathode side of the membrane electrode assembly.

Because electrons are formed at the anode side of the membrane electrode assembly, the anode reactant undergoes oxidation during the fuel cell reaction. Because electrons are consumed at the cathode side of the membrane electrode assembly, the cathode reactant undergoes reduction during the fuel cell reaction.

For example, when molecular hydrogen and molecular oxygen are the reactants used in a fuel cell, the molecular hydrogen flows through the anode flow field plate and undergoes oxidation. The molecular oxygen flows through the cathode flow field plate and undergoes reduction. The specific reactions that occur in the fuel cell are represented in equations 1-3.
H₂→2H⁺+2e⁻ (1)
½O₂+2H⁺+2e⁻→H₂O (2)
H₂+½O₂→H₂O (3)

As shown in equation 1, the molecular hydrogen forms protons (H⁺) and electrons. The protons flow through the electrolyte to the cathode side of the membrane electrode assembly, and the electrons flow from the anode side of the membrane electrode assembly to the cathode side of the membrane electrode assembly through the external load. As shown in equation 2, the electrons and protons react with the molecular oxygen to form water. Equation 3 shows the overall fuel cell reaction.

In addition to forming chemical products, the fuel cell reaction produces heat. One or more coolant flow field plates are typically used to conduct the heat away from the fuel cell and prevent it from overheating.

Each coolant flow field plate has an inlet region, an outlet region and channels that provide fluid communication between the coolant flow field plate inlet region and the coolant flow field plate outlet region. A coolant (e.g., liquid de-ionized water) at a relatively low temperature enters the coolant flow field plate at the inlet region, flows through the channels of the coolant flow field plate toward the outlet region of the coolant flow field plate, and exits the coolant flow field plate at the outlet region of the coolant flow field plate. As the coolant flows through the channels of the coolant flow field plate, the coolant absorbs heat formed in the fuel cell. When the coolant exits the coolant flow field plate, the heat absorbed by the coolant is removed from the fuel cell.

To increase the electrical energy available, a plurality of fuel cells can be arranged in series to form a fuel cell stack. In a fuel cell stack, one side of a flow field plate functions as the anode flow field plate for one fuel cell while the opposite side of the flow field plate functions as the cathode flow field plate for another fuel cell. This arrangement may be referred to as a bipolar plate. The stack may also include monopolar plates such as, for example, an anode coolant flow field plate having one side that serves as an anode flow field plate and another side that serves as a coolant flow field plate. As an example, the open-faced coolant channels of an anode coolant flow field plate and a cathode coolant flow field plate may be mated to form collective coolant channels to cool the adjacent flow field plates forming fuel cells.

### SUMMARY

In one aspect, the invention features a method of operating a fuel cell, which enables the fuel cell to receive optimal inputs throughout the lifetime of the fuel cell. For example, one or more performance characteristics can be measured that can correspond to the health of the fuel cell. Examples of performance characteristics include fuel cell performance, performance fluctuation, performance degradation, and performance degradation rate. The performance characteristic can then be used as feedback to the fuel cell, for example to an input controller, and the input controller can the adjust one or more inputs to the fuel cell to provide one or more improved performance characteristics.

In one aspect, the invention features a method of operating a fuel cell, the method comprising: operating the fuel cell at a first relative humidity; operating the fuel cell at a second relative humidity for a time, t, wherein the second relative humidity is different (e.g., lower) from the first relative humidity; and operating the fuel cell at a third relative humidity, wherein the third relative humidity is different (e.g., higher) from the second relative humidity.

In another aspect, the invention features a method of operating a fuel cell, the method comprising: operating the fuel cell at a first reactant stoichiometry; operating the fuel cell at a second reactant stoichiometry for a time, t, wherein the second reactant stoichiometry is different from the first reactant stoichiometry; and operating the fuel cell at a third reactant stoichiometry, wherein the third reactant stoichiometry is different from the second reactant stoichiometry.

In another aspect, the invention features a method of operating a fuel cell, the method comprising: operating the fuel cell at a first current density; operating the fuel cell at a second current density for a time, t, wherein the second current density is different (e.g., higher) from the first current density; and operating the fuel cell at a third current density, wherein the third current density is different (e.g., lower) from the second current density.

In another aspect, the invention features a method of operating a fuel cell, the method comprising: operating the fuel cell at a first temperature; operating the fuel cell at a second temperature for a time, t, wherein the second temperature is different (e.g., higher) from the first temperature; and operating the fuel cell at a third temperature, wherein the third temperature is different (e.g., lower) from the second temperature.

Embodiments can have one or more of the following advantages:

In some embodiments, the methods result in the fuel cell exhibiting reduced flooding during use, and/or improved water uptake within the membrane electrode assembly.

In some embodiments, the methods result in the fuel cell exhibiting enhanced performance during use. For example, in some embodiments, the methods described herein can result in fuel cells having improved voltage output, such as a gain in cell performance of at least about 10 mV, e.g., about 20 mV, about 30 mV, or about 40 mV. Without wishing to be bound by theory, it is believed that temporarily reducing the relative humidity in a fuel cell, for example by operating the fuel cell at sub-saturation for a limited time, can allow excess water in the fuel cell system to be removed, thereby decreasing any flooding of the fuel cell system to provide a gain in cell performance. In some embodiments, when a fuel cell is operated for a limited time at a relatively high current density, the cell operates temporarily at a higher localized temperature and thus a higher steam partial pressure, which can also provide a gain in cell performance. In some embodiments, the enhanced performance can last for at least about 2 hours, e.g., about 4 hours, about 8 hours, about 12 hours, about 1 day, about 2 days, about 3 days, about 4 days, about 5 days, about 6 days, about 1 week, about 2 weeks, or about 3 weeks.

In some embodiments, the methods result in a fuel cell exhibiting improved fuel cell stability, increased fuel cell lifetime, and/or increased signal to noise ratio.

Other features and advantages will be apparent from the description, drawings and from the claims.

### DESCRIPTION OF DRAWINGS

FIG. 1 is a cross-sectional view of an embodiment of a fuel cell.

FIG. 2 is a line graph comparing performance of a single cell fuel cell before and after the fuel cell was operated under conditions of sub-saturation (i.e., less than 100% relative humidity).

FIG. 3 is a line graph depicting the change in AC impedance spectra of a single cell fuel cell at varying relative humidities.

FIG. 4 is a line graph comparing performance of a fuel cell stack before and after the fuel cell stack was operated under conditions of sub-saturation (i.e., less than 100% relative humidity).

FIG. 5 is a line graph depicting the change in performance of a single cell fuel cell after a change in relative stoichiometry of the reactant gasses in the fuel cell.

FIG. 6 is a line graph depicting the change in performance of a single cell fuel cell after a change in relative stoichiometry of the reactant gasses in the fuel cell.

FIG. 7 is a line graph depicting the increased water uptake in the membrane electrode assembly as corresponds to increased temperature.

FIG. 8 is a line graph depicting the change in performance of a fuel cell module after a change in the current density of the fuel cell module.

Like reference symbols in the various drawings indicate like elements.

### DETAILED DESCRIPTION

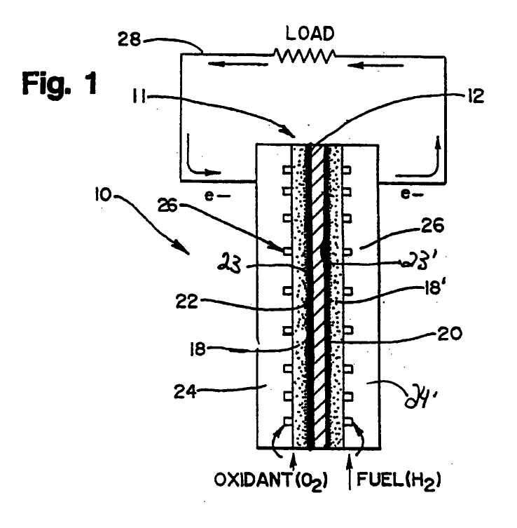

FIG. 1 shows a schematic diagram of a fuel cell 10, in cross-section including a membrane electrode assembly 11. Membrane electrode assembly 11 includes an electrolyte in the form of a solid polymer ion exchange membrane 12 disposed between a pair of diffusion layers 18 and 18′. Catalyst layers 23 and 23′ are disposed between diffusion layers 18 and 18′ and electrolyte 12.

A pair of electrically conductive flow field plates 24 and 24′ are provided on the side of each diffusion layer 18 and 18′ facing away from membrane 12. Flow field plates 24 and 24′ are made of graphite. Flow field plates 24 and 24′ are each provided with at least one groove or channel 26 for directing the fuel and oxidant gases to the anode and cathode respectively. Channels 26 can also serve as passageways for the removal of accumulated water from cathode 22 and anode 20. Flow field plates 24 and 24′ can further serve as the connections to an external electrical circuit 28 through which the electrons formed at the anode flow, as indicated by the arrows in FIG. 1.

In operation, the hydrogen-containing gas supply (designated “fuel” in FIG. 1) permeates diffusion layer 18′ and reacts at the catalyst layer 23′ to form cations (hydrogen ions). The hydrogen ions migrate across membrane 12 to cathode 22. At cathode 22, the cations react with the oxygen-containing gas supply (designated “oxidant” in FIG. 1) and electrons at the catalyst layer to form liquid water.

In fuel cells of the type illustrated in FIG. 1, water can accumulate at the cathode as a result of the formation of product water from the reaction of hydrogen ions, electrons, and oxygen at the cathode. In addition, if the membrane employed in the fuel cell exhibits a water pumping phenomenon in the transport of hydrogen ions across the membrane from the anode to the cathode, such transported water can accumulate at the cathode along with product water. In some embodiments, the accumulated water causes flooding of the fuel cell, which can result in reduced fuel cell performance. Accumulated water can be removed, for example, with the reactant gas streams exiting the fuel cell. The ability of the reactant gas streams to absorb and carry water vapor is related to various physical characteristics of the reactant gas, for example the relative humidity, the temperature, the stoichiometry, and the pressure of the reactant gas.

In many embodiments it is desirable to operate a fuel cell at 100% relative humidity. However, this can lead to flooding of the fuel cell, for example flooding of the electrodes, and for example flooding of the flow-fields. Accordingly, it can be desirable to temporarily operate the fuel cell at a reduced relative humidity. In some embodiments, the fuel cell can operate with varied relative humidity. For example, the fuel cell is operated at a first relative humidity, such as 100% relative humidity, and then the fuel cell is operated at a second, reduced, relative humidity, for example about 80% relative humidity, and the fuel cell is then again operated at a third, higher relative humidity, such as 100% relative humidity. In general, the fuel cell is continuously operated as the relative humidity of the fuel cell is altered. In some embodiments, the fuel cell is operated at the second relative humidity for a time sufficient to provide an increase in a performance characteristic of the fuel cell (e.g., voltage output). For example, when the fuel cell is operated at a second relative humidity that is less than 100% relative humidity, some accumulated water from the fuel cell can be removed from the fuel cell by being transformed into water vapor and being removed through a fuel cell outlet e.g., with an unsaturated reactant gas.

In many embodiments, the first and third relative humidities of the fuel cell are about 100%. However, in some embodiments, either one or both of the first and third relative humidities is less than about 100%, e.g., about 80%, about 85%, about 87%, about 88%, about 89%, about 90%, about 91%, about 92%, about 93%, about 94%, about 95%, about 96%, about 97%, about 98%, or about 99%. In many embodiments the first and third relative humidities are about the same. However, in some embodiments, the first and third humidities are different. For example, the first relative humidity can be about 100%, and the third relative humidity can be about 95%.

In some embodiments, for example if a performance characteristic indicates flooding, the second relative humidity is generally lower than the first relative humidity, and in some embodiments is also lower than the third relative humidity. Examples of second relative humidities include about 50%, about 55%, about 60%, about 65%, about 70%, about 71%, about 72%, about 73%, about 74%, about 75%, about 76%, about 77%, about 78%, about 79%, about 80%, about 85%, or about 90%.

In general, the fuel cell is operated at the second relative humidity for a time sufficient to provide a gain in at least one performance characteristic of the fuel cell. The length of time that the fuel cell is operated at the second relative humidity can vary, for example, according to the performance of the fuel cell. For example, when the fuel cell is operated at a lower relative humidity, e.g., 50%, less time of operation at this second relative humidity can be required to provide a performance gain than if the second relative humidity is higher, e.g., 80%. The length of time the fuel cell is operated at the second relative humidity can also depend on whether the fuel cell is flooded, and if the fuel cell is flooded, the degree of flooding. In some embodiments, the fuel cell is operated at a second relative humidity for at least about 1 minute, e.g., about 5 minutes, about 10 minutes, about 20 minutes, about 30 minutes, about 45 minutes, about 60 minutes, about 75 minutes, about 90 minutes, about 120 minutes, or about 150 minutes. In some embodiments, the fuel cell is operated at a second relative humidity for at most about 1 day, e.g., about 12 hours, about 11 hours, about 10 hours, about 9 hours, about 8 hours, about 7 hours, about 6 hours, about 5 hours, about 4 hours, about 3 hours, about 2 hours, about 1 hour, or about 30 minutes.

In some embodiments, when a fuel cell is continuously run at a first relative humidity, a second relative humidity, and a third relative humidity, an increase in at least one performance characteristic can be seen at the second or third relative humidity relative to the first relative humidity. For example, the voltage output of the fuel cell can be increased at the second or third relative humidity relative to the first relative humidity, the signal to noise ratio of the fuel cell can be increased at the second or third relative humidity relative to the first relative humidity, or the AC impedance can be improved at the third relative humidity relative to the first relative humidity.

The relative humidity of the fuel cell can be reduced in a number of ways. For example, the relative humidity of one or more reactant gases, e.g., anode reactant gas and/or cathode reactant gas, can be reduced. In some embodiments, the relative humidity of a reactant gas is reduced by temporarily decreasing the humidification temperature of the reactant gas, e.g., the anode reactant gas and/or the cathode reactant gas. Decreasing the humidification temperature of a reactant gas can cause the reactant gas to absorb less water during the humidification process of the gas, thus allowing the reactant gas to enter into the fuel cell at less than 100% relative humidity (e.g., where the fuel cell temperature is higher than the humidification temperature of the reactant gas). Because the reactant gas is at less than 100% relative humidity, it can absorb water from the fuel cell as it passes through the fuel cell, thus reducing any flooding of the fuel cell. In general, a fuel cell is operated at about 60° C., e.g., about 5° C., about 10° C., about 30° C., about 40° C., about 45° C., about 50° C., about 55° C., or about 60° C.; and at most about 80° C., about 75° C., about 70° C., about 65° C., or about 60° C. When the reactant inlet temperature is reduced to provide a reactant gas having a reduced relative humidity, the inlet temperature is generally reduced by at least about 1° C. and most about 20° C., e.g., at least about 1° C., about 2° C., about 3° C., about 4° C., about 5° C., about 6° C., about 7° C., and at most about 15° C., about 14° C., about 13° C., about 12° C., about 11° C., or about 10° C.

The relative humidity of one or more reactant gasses, e.g., anode reactant gas and/or cathode reactant gas, can be reduced by introducing the reactant gas at a temporarily higher inlet pressure. For example, if the reactant gas is introduced at a pressure higher than the pressure in the fuel cell, the drop in pressure of the reactant gas can allow the reactant gas to absorb moisture from the fuel cell as the reactant gas passes through the fuel cell. In general the fuel cell is operated with a reactant inlet pressure of about several psi. For example, at least about 1 psi and at most about 50 psi. When the reactant inlet pressure is increased to provide a reactant gas with a reduced relative humidity, the reactant inlet pressure is generally increased by about more than 1 psi.

In some embodiments, the relative humidity of the fuel cell can be reduced by changing one or more parameters of a coolant that is used to cool the fuel cell. For example, the flow rate of the coolant can be reduced, thus resulting in an increase in temperature of the fuel cell. By temporarily increasing the temperature of the fuel cell, the temperature of one or more reactant gasses, e.g., anode reactant gas and/or cathode reactant gas, will be increased (and the relative humidity of one or more of the reactant gasses will be decreased), thus allowing the reactant gas to absorb moisture from the fuel cell. Alternatively, the temperature of the fuel cell can be increased by increasing the temperature of the coolant. In general, the coolant flow rate is at least about 0.1 l/min and at most about 10 l/min for a 5 kW fuel cell system. For example, at least about 0.2 l/min, about 0.3 l/min, about 0.4 l/min, about 0.5 l/min, about 0.6 l/min, about 0.7 l/min, about 0.8 l/min, about 0.9 l/min, or about 10 l/min, and at most about 5 l/min, about 4.5 l/min, about 4 l/min, about 3.5 l/min, or about 3 l/min. When the coolant flow rate is reduced to provide a fuel cell having a reduced relative humidity, the coolant flow rate is generally reduced by at least about 1% and at most about 50%. In general, the coolant temperature is about 60° C., e.g., at least about 40° C., about 45° C., about 50° C., or about 55° C., and at most about 80° C., about 75° C., about 70° C., or about 65° C. When the coolant temperature is increased to provide a fuel cell having a reduced relative humidity, the coolant temperature is generally increased by at least about 1° C. and at most about 20° C.

In some embodiments, the relative humidity of a fuel cell can be altered by creating a thermal gradient within the fuel cell. For example, a flow field plate in the fuel cell can be temporarily operated at a higher temperature than the membrane electrode assembly, to cause a thermal gradient within the fuel cell. The higher temperature at the fuel plate can cause the temperature of one or more reactant gasses to increase, thus reducing the relative humidity of the gas. If the relative humidity of the reactant gas is then less than 100%, the reactant gas can then absorb moisture from the fuel cell and reduce flooding of the fuel cell.

In some embodiments, the relative humidity of the fuel cell can be reduced by temporarily passing an absorbent gas through the fuel cell. The absorbent gas can be mixed with one or more reactant gasses. Examples of absorbent gasses include carbon dioxide and nitrogen. In general, any gas with a relative humidity of less than 100% can be used as an absorbent gas, thus removing moisture from the fuel cell as the gas passes through the fuel cell.

In some embodiments, at least one performance characteristic of a fuel cell can be increased by temporarily altering the stoichiometry of the reactants in the fuel cell. The term “reactant stoichiometry” as defined herein the ratio of the amount of reactant gas provided to the fuel cell to the amount of reactant gas consumed electrochemically in the fuel cell. For example, a reactant stoichiometry of 1.0/1.0 anode/cathode describes a fuel cell that is provided the theoretical amount of anode and cathode reactants, whereas a reactant stoichiometry of 1.2/2.0 anode/cathode describes a fuel cell that is provided 1.2 times the amount of anode needed and 2.0 times the amount of cathode needed.

In some embodiments, the reactant stoichiometry of the fuel cell is temporarily modified, for example increased based on a performance characteristic of the fuel cell. For example, an initial reactant stoichiometry of 1.2/2.0 anode/cathode can be temporarily modified to 1.5/2.0 anode/cathode if flooding is detected, for example anode flooding. Alternatively, the reactant stoichiometry can be decreased, for example if a performance characteristic indicates drying of the fuel cell. For example, the initial reactant stoichiometry of 1.2/2.0 anode/cathode can be reduced to 1.2/1.8 anode/cathode. In some embodiments the increase or decrease in reactant stoichiometry can be achieved by increasing or decreasing the flow respectively of one or more reactants through the fuel cell. In case of increasing the reactant stoichiometry, the greater flow of reactant through the fuel cell can physically push moisture through the fuel cell. Varying the reactant stoichiometry can also result in varied current density and/or fuel cell temperature by increasing (or decreasing) the volume of reactants in the fuel cell. Examples of suitable initial reactant stoichiometries include 1.2/2.0. Examples of suitable varied reactant stoichiometries include 1.1-1.5/1.5-3.0. The fuel cell is generally operated at a varied reactant stoichiometry for a time sufficient to provide at least one enhanced performance characteristic of a fuel cell.

In some embodiments, it is desirable to temporarily vary the current density of a fuel cell. Increasing the current density of the fuel cell can cause the fuel cell to have a higher localized temperature and/or a higher steam partial pressure. The higher temperature of the fuel cell can result in an increase in the ability of an ionomer in the membrane electrode assembly to transport water. In general, more water can be absorbed through an ionomer such as commercially available NAFION® as the temperature of the NAFION® is increased. This can allow a greater number of water molecules to participate in proton transport than would be allowed at lower temperatures. Additionally, where the higher current density can lead to a higher steam partial pressure, this can effectively provide enhanced hydration to the ionomer. For example, in some embodiments, at least one performance characteristic of a fuel cell can be increased by temporarily increasing the current density of the fuel cell and then running the fuel cell at its initial current density. Examples of initial fuel cell current densities include, at least about 0.05 A/cm² and at most about 0.6 A/cm². Examples of elevated fuel cell current densities include at least about 0.4 A/cm² and at most about 3.0 A/cm². The fuel cell is generally operated at the higher current density for a time sufficient to provide at least one increased performance characteristic of the fuel cell.

In some embodiments, it is desirable to temporarily vary the temperature of a fuel cell. For example, in some embodiments, at least one performance characteristic of a fuel cell can be increased by temporarily increasing the temperature of the fuel cell, and then running the fuel cell again at its initial temperature. As discussed above, increased temperature of the fuel cell can provide, among other advantages, improved water transport rate. Additionally, a higher temperature in the fuel cell can provide a higher proton conductivity of the membrane electrode assembly. A higher temperature in the fuel cell may also provide a higher CO tolerance in the fuel cell. Examples of initial fuel cell temperatures include at least about 30° C. and at most about 60° C. Examples of elevated fuel cell temperatures include at least about 50° C. and at most about 90° C. The fuel cell is generally operated at the higher temperature for a time sufficient to provide at least one increased performance characteristic of the fuel cell.

While the fuel cell 10 illustrated in FIG. 1 contains only one membrane electrode assembly 11, it will be appreciated that fuel cell 10 can have a plurality of membrane electrode assemblies 11 connected in series with suitable separator plates between adjacent membrane electrode assemblies 11. Such a series of assemblies 11 is generally referred to as a “fuel cell stack”.

Typically, flow field plates 24 and 24′ are made of a carbon material (e.g., graphite, such as porous graphite or nonporous graphite).

Electrolyte 12 is generally configured to allow ions to flow therethrough while providing a substantial resistance to the flow of electrons. In some embodiments, electrolyte 12 is a solid polymer (e.g., a solid polymer ion exchange membrane), such as a solid polymer proton exchange membrane (e.g., a solid polymer containing sulfonic acid groups). Such membranes are commercially available from, for example, E.I. DuPont de Nemours Company (Wilmington, Del.) under the trademark NAFION. Electrolyte 12 can also be prepared from the commercial product GORE-SELECT, available from W.L. Gore & Associates (Elkton, Md.).

Catalyst 23′ can be made of a material capable of interacting with hydrogen to form protons and electrons. Examples of such materials include, for example, platinum, platinum alloys, such as platinum-ruthenium, and platinum dispersed on carbon black. Catalyst 23 can further include an electrolyte, such as an ionomeric material, e.g., NAFION®, that allows the anode to conduct protons. Alternatively, a suspension is applied to the surfaces of diffusion layers (described below) that face electrolyte 12, and the suspension is then dried. In some embodiments, a catalyst material (e.g., platinum) can be applied to electrolyte 12 using standard techniques. The method of preparing catalyst 23′ may further include the use of pressure and temperature to achieve bonding.

Catalyst 23 can be maede of a material capable of interacting with oxygen, electrons and protons to form water. Examples of such materials include, for example, platinum, platinum alloys, and noble metals dispersed on carbon black. Catalyst 23 can further include an electrolyte, such as an ionomeric material, e.g., NAFION®, that allows the cathode to conduct protons. Catalyst 23 can be prepared as described above with respect to catalyst 23′.

In general, diffusion layers 18 and 18′ are electrically conductive so that electrons can flow from catalyst 23 to flow field plate 24 and from flow field plate 24′ to catalyst 23′. Diffusion layers can be made of a material that is both gas and liquid permeable. It may also be desirable to provide the diffusion layers with a planarizing layer, for example, by infusing a porous carbon cloth or paper with a slurry of carbon black followed by sintering with a polytetrafluoroethylene material. Suitable diffusion layers are available from various companies such as E-TEK in Somerset, N.J., SGL in Valencia, Calif., and Zoltek in St. Louis, Mo.

### EXAMPLES

### Example 1

### Enhanced Performance of a Fuel Cell after Temporary Operation of the Fuel Cell under Conditions of Sub-Saturation

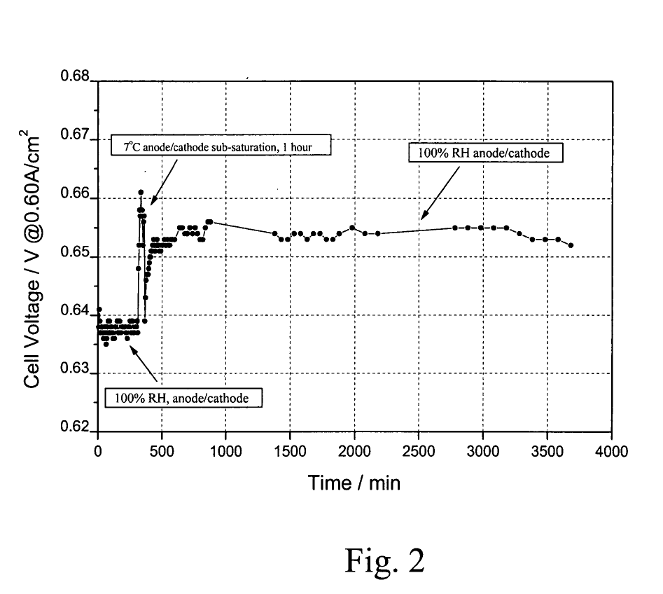

A 50 cm² single fuel cell was operated such that both the anode and cathode reactant gasses were introduced into the fuel cell at 100% relative humidity (RH) for about 500 hours. While continuously operating the fuel cell, the RH of both the anode and cathode reactant gasses were reduced for about one hour by lowering the reactant inlet temperature of the anode and cathode reactant gasses by 7° C. After about 1 hour, the RH of both the anode and cathode reactant gasses was restored to about 100% RH. The fuel cell performance is depicted in FIG. 2. As can be seen by the line graph, the initial operation of the fuel cell at 100% RH provided a fuel cell having a voltage output of about 0.638 V. After the fuel cell was operated at sub-saturation conditions for about 1 hour, and was again operated at about 100% RH, the fuel cell had a voltage output of about 0.655 V. This effect was demonstrated to last at least about 3500 minutes. The fuel cell was run at 65° C., 0.60 A/cm², ambient pressure, and 1.2/2.0 reformate/air stoichiometry, where the reformate contained 10 ppm CO.

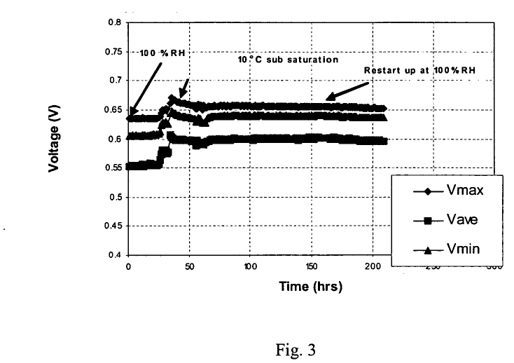

As shown in FIG. 3, temporary operation of the fuel cell under conditions of sub-saturation was also demonstrated to improve the AC impedance spectra of the fuel cell. AC impedance is a technique that can perturb the fuel cell with an alternating signal of small magnitude and observe the way in which the fuel cell system follows the perturbation at steady state. Referring to FIG. 3, the initial relative humidity was 100% and the largest arc was the impedance spectrum after the fuel cell was operated at this relative humidity for several hundreds of hours. The relative humidity was then reduced by lowering to 7° C. sub-saturation condition, and the impedance spectrum was indicated by the smallest arc, showing much less mass transport resistance. When the relative 5 humidity was then returned to 100%, the mass transport resistance increased, but it was still much less than that before the 7° C. sub-saturation perturbation.

### Example 2

### Enhanced Performance of a 15-Cell Fuel Cell Module after Temporary Operation of the Fuel Cell under Conditions of Sub-Saturation

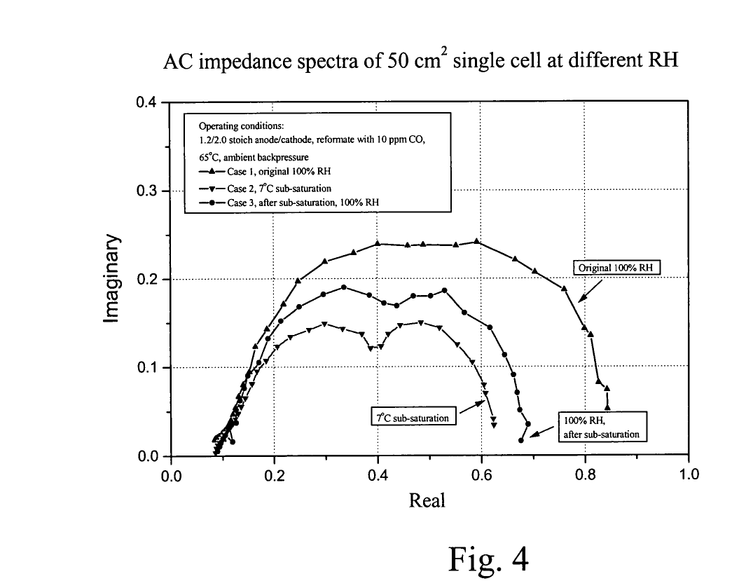

A 15-cell fuel cell module was operated under the same conditions as described above in Example 1. However, instead of operating the reactant inlet temperatures temporarily at 7° C. sub-saturation for about 1 hour as in Example 1, the reactant inlet temperatures were temporarily operated at 10° C. sub-saturation for about 120 minutes. As shown in FIG. 4, temporary operation of the fuel cell stack under conditions of sub-saturation provided an increase in minimum cell voltage output of about 50 mV.

### Example 3

### Enhanced Performance of a Fuel Cell after Temporary Operation of the Fuel Cell under Conditions of High Cathode Stoichiometry

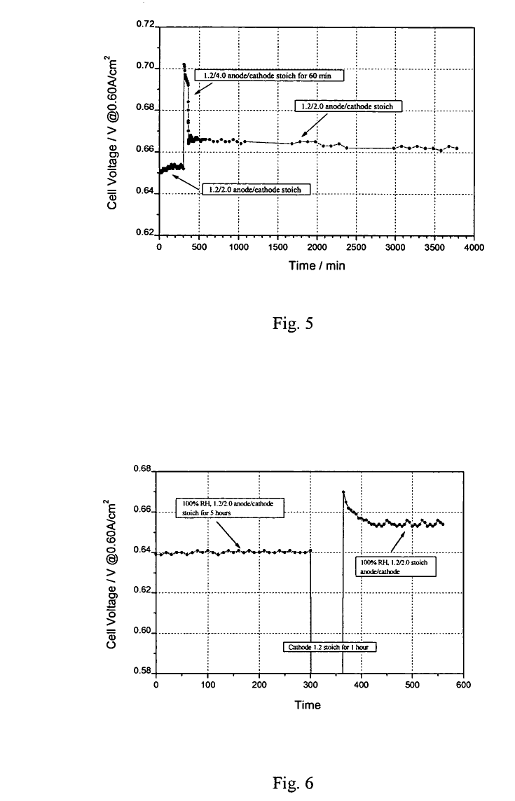

A single cell fuel cell was operated at a current density of 0.60 A/cm² under stoichiometric conditions of 1.2/2.0 anode/cathode, and while continuously operating the fuel cell, the stoichiometric conditions were altered for about 1 hour to 1.2/4.0 anode/cathode. While continuously operating the fuel cell, the initial stoichiometric conditions were restored, and the fuel cell was operated for about 3500 minutes. As shown in FIG. 5, the cell voltage output of the fuel cell at 1.2/2.0 anode/cathode was increased by about 10-15 mV after the fuel cell was operated under the 1.2/4.0 anode/cathode stoichiometric conditions for about an hour. This enhanced cell voltage output was maintained for the remainder of time that the fuel cell was operated. Operation conditions of the single fuel cell included a temperature of 65° C., 100% relative humidity, and reformate/air, where the reformate contained 10 ppm CO.

### Example 4

### Enhanced Performance of a Fuel Cell after Temporary Operation of the Fuel Cell under Conditions of Low Cathode Stoichiometry

A single cell fuel cell was operated at a current density of 0.60 A/cm² under stoichiometric conditions of 1.2/2.0 anode/cathode, and while continuously operating the fuel cell, the stoichiometric conditions were altered for about 1 hour to 1.2/1.2 anode/cathode. While continuously operating the fuel cell, the initial stoichiometric conditions were restored, and the fuel cell was operated for about 200 minutes. As shown in FIG. 6, the cell voltage output of the fuel cell was increased by more than 10 mV after the fuel cell was operated under the 1.2/1.2 anode/cathode stoichiometric conditions for about an hour. This enhanced cell voltage output was maintained for the remainder of time that the fuel cell was operated.

### Example 5

### Enhanced Water Uptake by a NAFION® Membrane as a Fuel Cell is Operated under Increasing Temperature

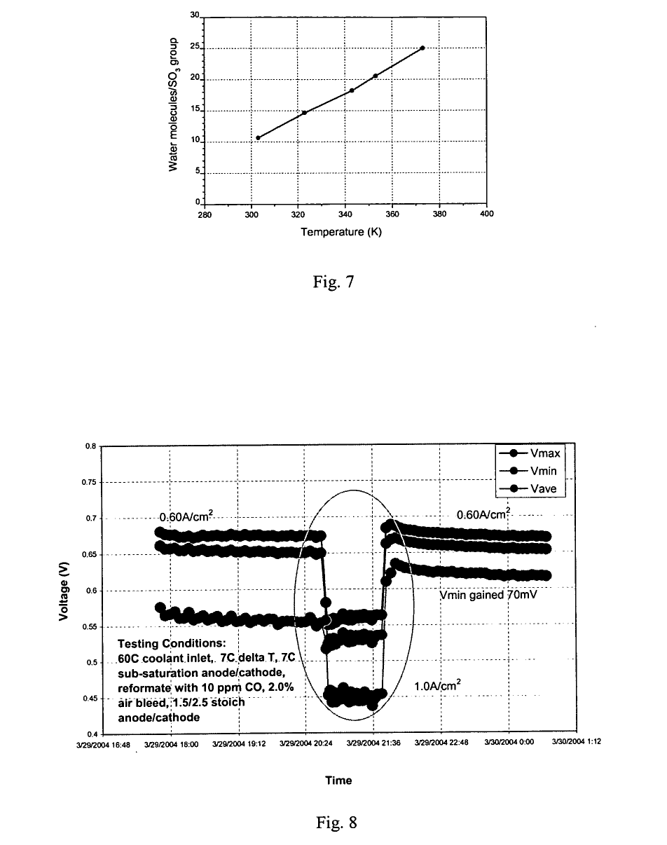

As can be seen from FIG. 7, as the uptake of water molecules by the —SO₃H moiety in the NAFION® membrane increases as the temperature increases.

### Example 6

### Enhanced Performance of a 15-Cell Fuel Cell Module after Temporary Operation of the Fuel Cell under Conditions of Increased Current Density

A 15-cell fuel cell module was operated under the following conditions: 60° C. coolant inlet temperature, 7° C. delta T (i.e., the coolant outlet temperature was 7° C. higher than the coolant inlet temperature), 7° C. sub-saturation reactant inlet temperature for both the anode and cathode reactant gasses including reformate with 10 ppm CO, 2.0% air bleed, and a 1.5/2.5 stoichiometry of anode/cathode. The fuel cell module was initially operated at 0.60 A/cm². While continuously operating the fuel cell module, the current density was increased for about 1 hour to 1.0 A/cm². After operating the fuel cell module at a current density of 1.0 A/cm², the fuel cell was then operated at the initial current density of 0.60 A/cm². As shown in FIG. 8, the performance of the fuel cell module was generally increased after temporarily operating the fuel cell at an increased current density. This effect was most pronounced in the voltage output of the minimally performing fuel cell as indicated by Vₘᵢₙ, which gained about 70 mV. While the maximally performing cell, Vₘₐₓ, and average performing cell, Vₐᵥₑ were also improved, this improvement was less than the improvement of Vₘᵢₙ.

While certain embodiments have been described, other embodiments are possible.

For example, while flow field plates have been described as being made of carbon materials, other materials can also be used.

As an additional example, while proton exchange fuel cells have been described, other fuel cells can also be used. Examples of fuel cells include phosphoric acid fuel cell, direct-feed liquid fuel cells, molten carbonate fuel cells, and solid oxide fuel cells. Examples of direct-feed liquid fuel cells include direct alcohol fuel cells, such as direct methanol fuel cells, direct ethanol fuel cells and direct isopropanol fuel cells.

The fuel cells can be used in a variety of applications, including, for example, in portable electronics, automobiles or stationary systems (e.g., systems designed to power a home).

Other embodiments are in the claims.

1. A method of operating a fuel cell, the method comprising;
operating the fuel cell at a first relative humidity;
operating the fuel cell at a second relative humidity for a time, t, wherein the second relative humidity is different from the first relative humidity; and
operating the fuel cell at a third relative humidity, wherein the third relative humidity is different from the second relative humidity.

2. The method of claim 1, wherein the second relative humidity is lower than the first relative humidity and the third relative humidity is higher than the second relative humidity.

3. The method of claim 1, wherein the fuel cell is continuously operated as a relative humidity of the fuel cell is modified between the first relative humidity, the second relative humidity and the third relative humidity.

4-40. (canceled)

41. A method of operating a fuel cell, the method comprising
operating the fuel cell at a first reactant stoichiometry;
operating the fuel cell at a second reactant stoichiometry for a time, t, wherein the second reactant stoichiometry is different from the first reactant stoichiometry; and
operating the fuel cell at a third reactant stoichiometry, wherein the third reactant stoichiometry is different from the second reactant stoichiometry.

42. The method of claim 41, wherein the fuel cell is continuously operated as a reactant stoichiometry of the fuel cell is modified between the first reactant stoichiometry, the second reactant stoichiometry and the third reactant stoichiometry.

43-54. (canceled)

55. A method of operating a fuel cell, the method comprising;
operating the fuel cell at a first current density;
operating the fuel cell at a second current density for a time, t, wherein the second current density is different from the first current density; and
operating the fuel cell at a third current density, wherein the third current density is different from the second current density.

56. The method of claim 55, wherein the second current density is higher than the first current density and the third current density is lower than the second current density.

57. The method of claim 55, wherein the fuel cell is continuously operated as a current density of the fuel cell is modified between the first current density, the second current density and the third current density.

58. The method of claim 55, wherein the time, t, is at least about 0.1 minutes.

59. The method of claim 55, wherein the time, t, is at most about 600 minutes.

60. The method of claim 55, wherein the first current density is at least about 0.01 A/cm².

61. The method of claim 55, wherein the first current density is at most about 3.0 A/cm².

62. The method of claim 55, wherein the second current density is at least about 0.01 A/cm².

63. The method of claim 55, wherein the second current density is at most about 3.0 A/cm².

64. The method of claim 55, wherein the third current density is at least about 0.01 A/cm².

65. The method of claim 55, wherein the third current density is at most about 3.0 A/cm².

66. The method of claim 55, wherein the first current density is about the same as the third current density.

67. The method of claim 55, wherein the fuel cell has a membrane electrode assembly having a first temperature at the first current density, a membrane electrode assembly having a second temperature at the second current density, and a membrane electrode assembly having a third temperature at the third current density; wherein the membrane electrode assembly temperature at the second current density is higher than the membrane electrode assembly temperature at each of the first current density and third current density.

68. The method of claim 55, wherein the fuel cell has a first percentage of water in a vapor phase at the first current density, a second percentage of water in a vapor phase at the second current density, and a third percentage of water in a vapor phase at the third current density; and wherein the percentage of water in the vapor phase at the second current density is greater than the percentage water in the vapor phase at each of the first current density and third current density.

69. The method of claim 55, wherein the fuel cell has a first amount of water production at the first current density, a second amount of water production at the second current density, and a third amount of water production at the third current density; wherein the second amount of water production at the second current density is greater than the first amount of water production at the first current density and the third amount of water production at the third current density.

70. The method of claim 55, wherein the fuel cell has a performance characteristic having a first value at the first current density and a third value at the third current density, the third value being greater than the first value.

71. The method of claim 55, wherein the fuel cell has a first relative humidity at the first current density, a second relative humidity at the second current density, and a third relative humidity at the third current density, the second relative humidity being different from each of the first and third relative humidities.

72. The method of claim 55, wherein the fuel cell has a first reactant stoichiometry at the first current density, a second reactant stoichiometry at the second current density, and a third reactant stoichiometry at the third current density, the second reactant stoichiometry being different from each of the first and third reactant stoichiometries.

73. The method of claim 55, wherein the fuel cell has a first temperature at the first current density, a second temperature at the second current density, and a third temperature at the third current density, the second temperature being different from each of the first and third temperatures.

74. A method of operating a fuel cell, the method comprising;
operating the fuel cell at a first temperature;
operating the fuel cell at a second temperature for a time, t, wherein the second temperature is different from the first temperature; and
operating the fuel cell at a third temperature, wherein the third temperature is different from the second temperature.

75. The method of claim 74, wherein the second temperature is higher than the first temperature and the third temperature is lower than the second temperature.

76. The method of claim 74, wherein the fuel cell is continuously operated as a temperature of the fuel cell is modified between the first temperature, the second current temperature and the third temperature.

77-90. (canceled)
